(19) United States
(12) Patent Application Publication
(10) Pub. No.: US 2015/0143768 A1
(43) Pub. Date: May 28, 2015

(54) Anhydrite Concrete Compositions and Methods to Manufacture Precast Building System

(71) Applicant: Rodrigo Mendoza-Lozano, Ciudad Juarez (MX)

(72) Inventor: Rodrigo Mendoza-Lozano, Ciudad Juarez (MX)

(21) Appl. No.: 14/556,005

(22) Filed: Nov. 28, 2014

Related U.S. Application Data
(60) Provisional application No. 61/909,865, filed on Nov. 27, 2013.

(51) Int. Cl. E04B 1/04; E04C 1/00; B29C 39/00; C04B 28/16

(52) U.S. Cl. CPC E04B 1/04; C04B 28/16; E04C 1/00; B29C 39/003; B29K 2509/06
USPC 52/596; 106/735; 264/333

(57) ABSTRACT

An improved concrete formulation comprising gravel, sand, Portland cement, and anhydrite substituting a portion of the Portland cement for fabrication of precast concrete systems with strength properties that comply with regulatory requirements.

### CROSS-REFERENCE TO RELATED APPLICATIONS

This application claims priority to and the benefit of the filing of U.S. Provisional Patent Application Ser. No. 61/909,865, entitled “ANHYDRITE CONCRETE COMPOSITIONS”, filed on Nov. 27, 2013, and the specification and claims thereof are incorporated herein by reference.

### BACKGROUND OF THE INVENTION

1. Field of the Invention (Technical Field)

Embodiments of the present invention relate to concrete formulations for, and methods to manufacture precast systems, and more particularly to concrete formulations comprising anhydrite (CaSO₄) as a partial substitute of Portland cement.

2. Description of Related Art

Precast concrete building systems such as blocks, paving stones, beams, columns, parking lot bumpers, decorative pieces, electricity poles, and the like, are fabricated of concrete generally comprising Portland cement. However, the cost of Portland cement continues to increase. This is problematic given that a significant amount of Portland cement is necessary in current formulations to achieve regulatory imposed compression resistance standards. See e.g., compressive strength standards delineated in Mexico's Secretaría de Comunicaciones y Transportes (SCT) rule N-CMT-2-01-002/02 for block for construction of buildings. Thus, there is a need to use suitable substitutes for Portland cement to decrease costs of precast concrete systems, which still maintain construction standards such as compression strength and maximum water absorption.

Embodiments of the present invention solve this problem by providing formulations in which a portion of the Portland cement required for concrete mixtures is substituted by anhydrite for fabrication of precast concrete systems with strength properties that comply with regulatory requirements. This reduces overall costs because anhydrite is less expensive. In addition, anhydrite is a byproduct generated in diverse industrial chemical processes and is treated as waste. Thus, anhydrite is a sustainable resource that can aid in reduction of costs for the manufacture of concrete precast products.

### BRIEF SUMMARY OF THE INVENTION

Embodiments of the invention comprise an improved concrete formulation comprising: gravel, sand, Portland cement, and anhydrite in an amount of between approximately 50% by weight and approximately 1% by weight of the Portland cement substituted by the anhydrite. Optionally, the formulation further comprises lime stone.

In one embodiment, the concrete formulation comprises anhydrite between approximately 25% by weight and approximately 3% by weight of the Portland cement substituted by the anhydrite. In one embodiment, between approximately 17% by weight and approximately 4% by weight of the Portland cement substituted by the anhydrite. In one embodiment, 10% by weight of the Portland cement is substituted by the anhydrite. In another embodiment, 15% by weight of the Portland cement is substituted by the anhydrite.

One embodiment of the invention comprises a precast concrete building system manufactured with concrete made with a formulation of the present invention, the building system comprising, for example, precast concrete blocks, or paving stones.

Another embodiment of the invention comprises a method to manufacture a precast building system comprising: measuring amounts of crushed lime stone, gravel, sand, Portland cement, water, and an amount of anhydrite to substitute a desired percentage of Portland cement; mixing and homogenizing heavy crushed limestone, gravel, and sand to create a first mixture; adding Portland cement to the first mixture to create a second mixture; mixing and homogenizing the second mixture; adding water to the second mixture to create a third mixture; mixing and homogenizing the third mixture; adding anhydrite to the homogenized third mixture to create a fourth mixture; mixing and homogenizing the fourth mixture; molding elements of the building system; compacting the building elements; casting the compacted elements of the building system; isolating the elements of the building system from the elements; and curing the elements of the building system at an appropriate temperature and relative humidity. In one embodiment the compacting comprises vibration. In one embodiment the curing is carried out for between 14 and 28 days.

Further scope of applicability of the present invention will be set forth in part in the detailed description to follow, taken in conjunction with the accompanying drawing, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawing:

FIG. 1 is a schematic diagram of an embodiment of the invention for the manufacture of precast concrete systems.

### DETAILED DESCRIPTION OF THE INVENTION

In the following detailed description, numerous specific details are set forth in order to provide a thorough understanding of the embodiments of the invention. However, it will be understood by one of ordinary skill in the art that the embodiments may be practiced without these specific details. For instance, well known operation or techniques may not be shown in detail. Technical and scientific terms used in this description have the same meaning as commonly understood to one or ordinary skill in the art to which this subject matter belongs.

As used throughout this specification and claims, the term “Portland cement” means cement compositions comprising calcium silicate minerals as listed by, but not limited, to the American Society for Testing and Materials (ASTM) Types I-V (“ordinary Portland cement”, or “OPC”), and White Portland cement (“WPC”)).

As used throughout this specification and claims, the term “precast concrete building systems” refers to building systems such as, but not limited to, blocks, paving stones, beams, columns, parking lot bumpers, decorative pieces, electricity poles, and the like, that are fabricated of concrete generally comprising Portland cement among other components.

Typical components of concrete include coarse aggregate (crushed stone or gravel), fine aggregate (usually natural sand), Portland cement, and water. In addition to these basic components, supplementary cementitious materials and chemical admixtures (e.g., lime stone) are often used to enhance or modify properties of the concrete. The coarse and fine aggregates used in concrete generally comprise about 80 to 85 percent of the mix by weight and Portland cement is 10 to 20 percent by weight. For every kilogram (or any unit of weight) of Portland cement, about 0.25 kg (or corresponding unit) of water is needed to fully complete the hydration reactions needed for the Portland cement to react. This requires a water-cement ratio of 1:4 often given as a proportion: 0.25. However, a mix with a w/c ratio of 0.25 may not mix thoroughly, and may not flow well enough to be placed, so more water is used than is technically necessary to react with the Portland cement. More typical water-cement ratios of 0.4 to 0.6 are used.

Embodiments of the present invention comprise concrete mix formulations in which a portion of Portland cement is substituted by anhydrite (CaSO₄). In one embodiment, preferably between approximately 50% by weight and approximately 1% by weight of Portland cement of a final mixture is substituted by anhydrite, more preferably between approximately 25% by weight and approximately 3% by weight of Portland cement of a final mixture is substituted by anhydrite, and most preferably, between approximately 17% by weight and approximately 4% by weight of Portland cement of a final mixture is substituted by anhydrite.

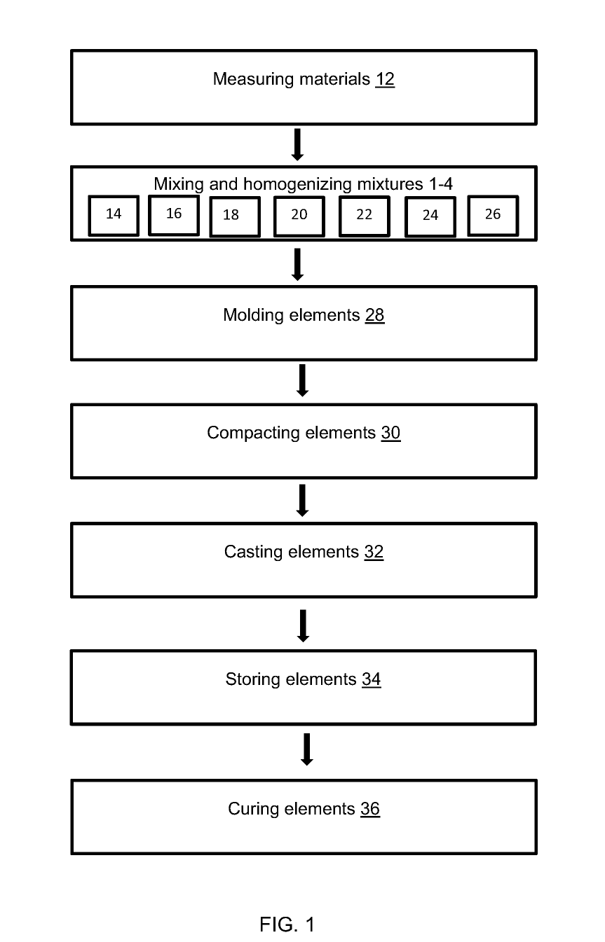

Referring to FIG. 1, embodiments of the present invention further comprise methods to manufacture precast concrete building systems wherein the concrete comprises a suitable amount of anhydrite as described above, the method preferably comprising the following steps: measuring amounts of materials for the concrete, including, for instance, crushed lime stone, gravel, sand, Portland cement, water, and an amount of anhydrite to substitute a desired percentage of Portland cement (12); preferably mixing and homogenizing heavy stone materials such as crushed limestone, gravel, and sand to create a first mixture (14); preferably adding Portland cement to the first mixture to create a second mixture (16); mixing and homogenizing the second mixture (18); preferably adding water to the second mixture to create a third mixture (20); preferably mixing and homogenizing the third mixture (22); preferably adding anhydrite to the homogenized third mixture to create a fourth mixture (24); preferably mixing and homogenizing the fourth mixture (26); preferably molding elements of the building system (28); preferably compacting the building elements with the aid of vibration (30); preferably casting the compacted elements of the building system (32); preferably isolating the elements of the building system from the elements (34); and preferably curing the elements of the building system at an appropriate temperature and relative humidity (36).

### INDUSTRIAL APPLICABILITY

The invention is further illustrated by the following non-limiting examples.

### Example 1

Precast hydraulic concrete blocks were manufactured in part according to standard criteria prescribed by the Grupo Cementos de Chihuahua (GCC).

The parameters and test of the materials used and the respective block samples followed the recommendations set out in the Rules of Mexico's SCT and the standards set by Mexico's Organismo Nacional de Normalización y Certificación de la Construcción y Edificación (ONNCCE).

The main materials that make hydraulic concrete block were identified, as well as the required equipment and manufacturing methodology that were used. The common materials used were: sand, Portland cement type I, gravel ⅜ inch, crushed limestone with maximum size of ⅜ inch, and water. The purpose was to economize precast production of building systems so anhydrite was employed as a Portland cement partial replacement at 5, 10 and 15%.

The manufacturing process of hydraulic concrete block was repeated in triplicates for the different proportions of anhydrite at 5, 10 and 15% as shown below in Table 1. The anhydrite had a pH of 7.0.

TABLE 1
Proportions used in the homogenization of the mixture.

| | Amounts in mixtures by hydraulic concrete block | | | | | |
|---|---|---|---|---|---|---|
| Materials | 5% | | 10% | | 15% | |
| Limestone Fallout ⅜ | 6.94 | kg | 6.94 | kg | 6.94 | kg |
| inch | | | | | | |
| Limestone grit ⅜ inch | 2.7 | kg | 2.7 | kg | 2.7 | kg |
| Silica sand | 3.38 | kg | 3.38 | kg | 3.38 | kg |
| Portland Cement CPC | 0.99 | kg | 0.94 | kg | 0.88 | kg |
| 30R | | | | | | |
| Water | 72% | | 72% | | 72% | |
| Anhydrite (CaSO₄) | 0.05 | g | 0.10 | kg | 0.16 | kg |

The desired amounts of anhydrite were measured on a weight scale, with the help of a bucket with a capacity of 20 liters. Next, the process of homogenizing the mixture of heavy stone materials for the manufacture of hydraulic concrete blocks was conducted in the following order: crushed limestone, gravel and sand. Homogenization was carried out in a Besser 80f mixer. Once this first homogenization of heavy stone was completed, Portland cement was added followed by water, and all the aforementioned components were homogenized for about 3 minutes. After this second homogenization, anhydrite was added followed by a third 2 minute homogenization.

The final mixture was transported to the molding equipment, which in this case was a Besser V312 model that molds the blocks and compacts them with the aid of vibration. Once casted, the blocks were placed on metal plates for confinement.

The molding machine had a system of belts and chains, which routed the metal plates with the fresh blocks to shelves designated for storage of precast materials.

Once the stacks reached the storage maximum capacity, the blocks were transported, with the help of a forklift, to the curing quarters. The curing quarter were spaces comprising a sprinkler system to provide water for the appropriate moisture to prevent premature drying, currents caused by wind or solar radiation, and to prevent leaching or contamination by unknown element from rainwater.

Once the curing rooms reached full capacity, they were closed to prevent the escape of moisture. The blocks were stored for 24 hrs. After that, the specimens were removed and transported to an area where they were stacked on pallets. Subsequently, the pallets were transferred to a storage yard.

Assays to determine the compressive strength of the specimens were conducted in accordance with Mexico SCT's rule N-CMT-2-01-002/02, which states that, to be accepted for use in the construction industry in both indoor walls as external walls, the minimum resistance force for hydraulic concrete block is 6 Mega Pascals (MPa) or its equivalent of 61.18 kg/cm2.

In the case of specimens prepared with 5, 10 and 15% replacement anhydrite in lieu of Portland cement, the samples were tested at 4, 7, 14 and 28 days after their manufacture, following the recommendations set out in NMX-C-036-ONNCCE ONNCCE-2004. The results obtained are shown in Table 2, which expresses the averages of the specimens used for the tests.

TABLE 2
Compressive strength of the sample tested

| Percentage of | | | | |
|---|---|---|---|---|
| anhydrite (CaSO₄) | Force compressive strength (kg/cm²) | | | |
| contained in the block | 4 days | 7 days | 14 days | 28 days |
| 5% | 30.84 | 41.03 | 48.86 | 59.04 |
| 10% | 45.11 | 47.39 | 58.76 | 73.31 |
| 15% | 30.09 | 29.26 | 49.08 | 67.38 |

Because the rule states that the minimum compressive strength must be approximately 60 kg/cm², the data obtained from the assays shows that strength increased as the blocks aged, with the greatest strengths resulting after 28 days of curing.

Unexpectedly, substituting Portland cement with anhydrite resulted in increases in strength of some of the samples. The highest strength results were derived with the 10% anhydrite substitution samples, in which the compressive strength was increased by almost 25% over 28 days.

Assays to determine percentage of water absorption were performed according to the ONNCCE rule NMX-C-037-ONNCCE-2005, which prescribes that the percentage of water absorption for hydraulic concrete block shall not exceed 20% of the specimen's weight.

In order to assess percentage of water absorption, the specimens were weighed dry and then again after having been submerged in clean water for 24 hours and drained for approximately 5 minutes.

The following formula was used to calculate the results:

$$\% absorption = \frac{{W}_{wet} - {W}_{dry}}{{W}_{dry}} * 100$$

Where:
W_{wet}=wet specimen weight after 5 min. draining
W_{dry}=dry specimen weight

Samples were tested at 4, 7, 14, and 28 days after manufacture to obtain the results shown in Table 3 below.

TABLE 3
Percentages of absorption of water

| Percentage of | | | | |
|---|---|---|---|---|
| anhydrite (CaSO₄) | Percentage of Water Absorption | | | |
| contained in the block | 4 days | 7 days | 14 days | 28 days |
| 5% | 4.92% | 6.67% | 5.82% | 5.53% |
| 10% | 4.59% | 2.99% | 5.34% | 4.94% |
| 15% | 6.12% | 3.94% | 5.51% | 5.47% |

As can be appreciated in these results, the percentage of water absorption of the samples is significantly lower (less than half) than the 20% prescribed by the regulation. Samples manufactured without anhydrite (data not shown) had an average of 7.0% three days after manufacture.

The preceding example can be repeated with similar success by substituting the generically or specifically described components and/or parameters of this invention for those used in the preceding examples. Note that in the specification and claims, “about” or “approximately” means within twenty percent (20%) of the numerical amount cited.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An improved concrete formulation comprising:
gravel;
sand;
Portland cement; and
anhydrite in an amount of between approximately 50% by weight and approximately 1% by weight of said Portland cement substituted by said anhydrite.

2. The concrete formulation of claim 1 comprising anhydrite between approximately 25% by weight and approximately 3% by weight of said Portland cement substituted by said anhydrite.

3. The concrete formulation of claim 1 comprising anhydrite between approximately 17% by weight and approximately 4% by weight of said Portland cement substituted by said anhydrite.

4. The concrete formulation of claim 3 comprising anhydrite 10% by weight of said Portland cement substituted by said anhydrite.

5. The concrete formulation of claim 3 comprising anhydrite 15% by weight of said Portland cement substituted by said anhydrite.

6. A precast concrete building system manufactured with concrete made with the formulation of claim 1.

7. The precast concrete building system of claim 6 wherein said system comprises precast concrete blocks.

8. The precast concrete building system of claim 6 wherein said system comprises paving stones.

9. A method to manufacture a precast building system comprising:
measuring amounts of crushed lime stone, gravel, sand, Portland cement, water, and an amount of anhydrite to substitute a desired percentage of Portland cement;
mixing and homogenizing heavy crushed limestone, gravel, and sand to create a first mixture;
adding Portland cement to the first mixture to create a second mixture;
mixing and homogenizing the second mixture;
adding water to the second mixture to create a third mixture;
mixing and homogenizing the third mixture;
adding anhydrite to the homogenized third mixture to create a fourth mixture;
mixing and homogenizing the fourth mixture;
molding elements of the building system;
compacting the building elements;
casting the compacted elements of the building system;
isolating the elements of the building system from the elements; and
curing the elements of the building system at an appropriate temperature and relative humidity.

10. The method of claim 9 wherein the compacting comprises vibration.

11. The method of claim 9 wherein the curing is carried out for between 14 and 28 days.

12. The concrete formulation of claim 1 further comprising crushed lime stone.
